(19) United States
(12) Patent Application Publication
(10) Pub. No.: US 2019/0296331 A1
(43) Pub. Date: Sep. 26, 2019

(54) POSITIVE ELECTRODE ACTIVE MATERIAL, POSITIVE ELECTRODE, AND RECHARGEABLE BATTERY

(71) Applicants: FUJI SILYSIA CHEMICAL LTD., Aichi (JP); National University Corporation Nagoya University, Aichi (JP)

(72) Inventors: Mitsuhiro Kamimura, Aichi (JP); Mitsuteru Ogawa, Aichi (JP); Kunio Awaga, Aichi (JP); Zhongyue Zhang, Aichi (JP); Yang Wu, Aichi (JP)

(21) Appl. No.: 16/464,103

(22) PCT Filed: Nov. 6, 2017
(86) PCT No.: PCT/JP2017/039932

§ 371 Date: May 24, 2019

(30) Foreign Application Priority Data
Nov. 25, 2016 (JP) 2016-228992

(51) Int. Cl. H01M 4/36; H01M 10/052; H01M 4/62; H01M 4/38; H01M 4/485

(52) U.S. Cl. CPC H01M 4/362; H01M 10/052; H01M 2004/028; H01M 4/38; H01M 4/485; H01M 4/621

(57) ABSTRACT

A positive electrode active material contains conductive silica and sulfur filled in pores of the conductive silica. The conductive silica is preferably a composite containing silica gel and fine particulate carbon dispersed in the silica gel. The positive electrode includes the aforementioned positive electrode active material. A rechargeable battery includes the aforementioned positive electrode.

### CROSS-REFERENCE TO RELATED APPLICATION

This application is a Section 371 National Stage Application of International Application No. PCT/JP2017/039932, filed Nov. 6, 2017, claims the benefit of Japanese Patent Application No. 2016-228992 filed on Nov. 25, 2016 with the Japan Patent Office, the entire disclosures of International Application No. PCT/JP2017/039932 and Japanese Patent Application No. 2016-228992 are incorporated in this international application by reference.

### TECHNICAL FIELD

The present disclosure relates to a positive electrode active material, a positive electrode, and a rechargeable battery.

### BACKGROUND ART

Lithium-sulfur batteries have been known in which sulfur is used as a positive electrode active material. Sulfur has a high theoretical capacity density that is 1672 mAh/g. The lithium-sulfur batteries thus are expected to be high capacity batteries (see Patent Document 1).

### PRIOR ART DOCUMENTS

### Patent Documents

Patent Document 1: Japanese Unexamined Patent Application Publication No. 2013-114920

### SUMMARY OF THE INVENTION

### Problems to be Solved by the Invention

The capacities of conventional lithium-sulfur batteries tend to easily decrease due to repeated charging and discharging. The reason is assumed to be that sulfur dissolves and disperses in an electrolytic solution.

It is preferable that one aspect of the present disclosure provides a positive electrode active material, a positive electrode, and a rechargeable battery that can inhibit reduction in capacity when charging and discharging are repeated.

### Means for Solving the Problems

One aspect of the present disclosure provides a positive electrode active material comprising conductive silica and sulfur. Use of the positive electrode active material according to one aspect of the present disclosure can provide a rechargeable battery having a capacity that does not easily decrease regardless of repeated charging and discharging.

Another aspect of the present disclosure provides a positive electrode active material comprising conductive silica and sulfur filled in pores of the conductive silica. Use of the positive electrode active material according to another aspect of the present disclosure can provide a rechargeable battery having a capacity that does not easily decrease regardless of repeated charging and discharging.

Still another aspect of the present disclosure provides a positive electrode comprising the positive electrode active material according to one aspect of the present disclosure, or the positive electrode active material according to another aspect of the present disclosure. Use of the positive electrode according to still another aspect of the present disclosure can provide a rechargeable battery having a capacity that does not easily decrease regardless of repeated charging and discharging.

A further another aspect of the present disclosure provides a rechargeable battery comprising the positive electrode according to still another aspect of the present disclosure. The rechargeable battery according to further another aspect of the present disclosure is configured such that the capacity thereof does not easily decrease regardless of repeated charging and discharging.

### BRIEF DESCRIPTION OF THE DRAWINGS

FIG. 1 is a lateral sectional view showing a configuration of a rechargeable battery;

FIG. 2 is a graph showing results of charging and discharging tests on coin cell batteries D1, D2, DR wherein a vertical axis represents a capacity based on the mass of sulfur in an active material; and

FIG. 3 is a graph showing results of charging and discharging tests on the coin cell batteries D1, D2, DR wherein the vertical axis represents the capacity based on the mass of the active material in a positive electrode.

### EXPLANATION OF REFERENCE NUMERALS

11 . . . lithium-ion rechargeable battery, 13 . . . negative electrode, 15 . . . positive electrode, 17 . . . separator, 19, 21 . . . power collecting members, 23 . . . upper case, 25 . . . lower case, 27 . . . gasket

### MODE FOR CARRYING OUT THE INVENTION

Example embodiments of the present disclosure will be described.

1. Positive Electrode Active Material

A positive electrode active material contains conductive silica. Examples of the conductive silica include a composite containing silica gel and fine particulate carbon. The fine particulate carbon is preferably dispersed in the silica gel. Hereinafter, this composite will be referred to as a silica gel-carbon composite. Examples of the silica gel-carbon composite include silica-carbon composite porous bodies disclosed in Japanese Unexamined Patent Application Publication No. 2013-56792 and Japanese Unexamined Patent Application Publication No. 2012-246153.

The specific surface area, the pore volume, and the average pore diameter of the silica gel-carbon composite are preferably within the following ranges. If the specific surface area, the pore volume, and the average pore diameter are within the following ranges, the characteristics of a rechargeable battery containing the positive electrode active material can be further enhanced.

Specific surface area: 20 to 1000 m²

Pore volume: 0.3 to 2.0 ml/g

Average pore diameter: 2 to 100 nm

The mass ratio of the fine particulate carbon relative to the total mass of the silica gel-carbon composite (hereinafter referred to as a carbon content) is preferably 1 to 50% by mass, and particularly preferably 5 to 35% by mass. If the carbon content is 1% by mass or more, the electrical conductivity of the silica gel-carbon composite is higher, and if the carbon content is 5% by mass or more, the electrical conductivity of the silica gel-carbon composite is particularly high. Moreover, if the carbon content is 50% by mass or less, the mechanical strength of the silica gel-carbon composite is higher, and if the carbon content is 35% by mass or less, the mechanical strength of the silica gel-carbon composite is particularly high.

The silica gel-carbon composite is preferably in a state where the fine particulate carbon is uniformly dispersed in the silica gel. If the silica gel-carbon composite is in this state, the electrical conductivity and the mechanical strength of the silica gel-carbon composite are higher.

The silica gel-carbon composite can be produced by, for example, a first production method, or a second production method to be described below.

(First Production Method)

A co-dispersion made of the fine particulate carbon dispersed in water by a surfactant, an alkali metal silicate aqueous solution, and a mineral acid is prepared. In this co-dispersion, a silica hydrosol and the fine particulate carbon are uniformly dispersed. The silica hydrosol is a reaction product of alkali metal silicate and mineral acid. Subsequently, the silica gel-carbon composite is prepared by gelling the silica hydrosol contained in the co-dispersion.

The silica gel-carbon composite may or may not contain the surfactant. After the gelation of the silica hydrosol contained in the co-dispersion, the surfactant can be removed by baking. The baking temperature is preferably in a rage of 200 to 500° C., and the baking time is preferably in a range of 0.5 to 2 hours. If the baking temperature and the baking time are in the aforementioned ranges, the surface area of the silica gel-carbon composite does not easily decrease.

The aforementioned co-dispersion can be prepared by, for example, adding the fine particulate carbon to one of the alkali metal silicate aqueous solution and the mineral acid and mixing therewith, and then further adding the other of the alkali metal silicate aqueous solution and the mineral acid and mixing together.

Moreover, the aforementioned co-dispersion can be prepared by, for example, by mixing the alkali metal silicate aqueous solution and the mineral acid to produce the silica hydrosol, and further adding the fine particulate carbon to the silica hydrogel and mixing the same.

Examples of the alkali metal silicate include lithium silicate, potassium silicate, and sodium silicate. Among these alkali metal silicates, sodium silicate is particularly preferable since it is easily available and economically efficient.

Examples of the fine particulate carbon include: carbon blacks such as furnace black, channel black, acetylene black, and thermal black; graphites such as a natural graphite, an artificial graphite, an expanded graphite; a carbon fiber; and a carbon nanotube.

The fine particulate carbon is highly hydrophobic and does not easily disperse in water in some cases. In such a case, use of the surfactant enables the fine particulate carbon to be dispersed in water. Examples of the surfactant include an anionic surfactant, a cationic surfactant, a nonionic surfactant, and an amphoteric surfactant.

For preparing the aforementioned co-dispersion, a commercially available aqueous dispersion of fine particulate carbon can be used. Examples of the commercially available aqueous dispersion of fine particulate carbon include Lion Paste W-310A, Lion Paste W-311N, Lion Paste W-356A, Lion Paste W-376R, and Lion Paste W-370C (all manufactured by Lion Corporation). Examples of the mineral acid include hydrochloric acid, sulfate, nitric acid, and carbonic acid.

(Second Production Method)

The silica gel-carbon composite may be produced as described below. Silicate ester or a polymer thereof are the raw materials of silica. The fine particulate carbon is added to the raw materials of silica and mixed therewith to produce a mixture. Subsequently, in that mixture, the co-dispersion of silica and carbon is prepared by hydrolyzing the raw materials of silica. Then, silica contained in the co-dispersion is gelated, which makes the co-dispersion porous, and the silica gel-carbon composite is produced. The specific surface area of the silica gel-carbon composite is, for example, 20 to 1000 m²/g. The pore volume of the silica gel-carbon composite is, for example, 0.3 to 2.0 ml/g. The average pore diameter of the silica gel-carbon composite is, for example, 2 to 100 nm.

Major examples of the raw materials of silica include ethyl silicate, methyl silicate, and partial hydrolysates thereof. The raw materials of silica may be other silicate ester than the aforementioned ones.

Examples of the fine particulate carbon used in the second production method include the fine particulate carbon used in the first production method. When water and a small amount of acid or alkaline are added as a catalyst to the aforementioned co-dispersion of silica and carbon, silicate ester is hydrolyzed to form colloidal silica, and then gelled. Mineral acid may preferably be used as the catalyst. As the mineral acid, hydrochloric acid, sulfate, nitric acid, and carbonic acid may be used, for example.

The conductive silica may be other silica than the silica gel-carbon composite. The conductive silica may be, for example, a mixture of silica and a conductive material. Examples of the conductive material include carbon particles.

The positive electrode active material contains sulfur. At least a part of sulfur is filled in the pores of the conductive silica. A sulfur content relative to the conductive silica is not particularly limited, but preferably be in the range of 30 to 80% by mass. If the sulfur content is 30% by mass or more, the sulfur content in the positive electrode increases and the discharge capacity per positive electrode increases. Moreover, if the sulfur content is 80% by mass or less, the amount of sulfur not filled in the pores of the conductive silica decreases and the electrical resistance of the conductive silica decreases, which further enhances the battery characteristics. The sulfur content means the amount of sulfur relative to the mass of the conductive silica which is defined to be 100.

Examples of a method to fill sulfur into the pores of the conductive silica include storing the conductive silica and sulfur in a vacuum-sealed container and heating the same. Publically-known methods may also be suitably selected and employed as the method for filling sulfur into the pores of the conductive silica.

In addition to the sulfur filled in the pores of the conductive silica, the positive electrode active material may further contain sulfur that is not filled in the pores of the conductive silica. The positive electrode active material may further contain other component(s) in addition to, for example, the conductive silica and sulfur. The aforementioned other component(s) can be suitably selected from publically-known components.

The positive electrode active material according to the present disclosure is suitable for producing positive electrodes in rechargeable batteries, and particularly suitable for producing positive electrodes in lithium-sulfur batteries.

2. Positive Electrode

The positive electrode comprises the positive electrode active material described in the section “1. Positive Electrode Active Material”. The positive electrode may comprise a publically-known configuration except the part of, for example, the positive electrode active material. The positive electrode comprises, for example, a layer containing the positive electrode active material (hereinafter referred to as a positive electrode active material layer) on a power collecting member on the positive electrode side. The positive electrode active material layer may consist only of the positive electrode active material, or may contain other component(s) in addition to the positive electrode active material.

Examples of the aforementioned other component(s) include a conductive additive, a binding agent, and a thickening agent. Since the conductive silica is electrically conductive, the positive electrode active material layer does not have to contain any conductive additive. As the conductive additive, an electron conductive material that does not negatively affect the battery performance, for example, can be used. As the electron conductive material, one or more selected from, for example, graphite including natural graphite (such as vein graphite, and flake graphite), and artificial graphite, acetylene black, carbon black, Ketjenblack, carbon whisker, needle coke, carbon fiber, and metal (such as copper, nickel, aluminum, silver, and gold) can be used.

Among these electron conductive materials, carbon black, Ketjenblack, and acetylene black that have good electron conductivities and coating properties are preferable.

The binding agent serves to bind, for example, particles of the positive electrode active material and particles of the conductive additive. As the binding agent, for example, a fluorine-containing resin such as polytetrafluoroethylene (PTFE), polyvinylidene difluoride (PVDF), fluororubber, a thermoplastic resin such as polypropylene, polyethylene, ethylene-propylene-diene monomer (EPDM), sulfonated EPDM, natural butyl rubber (NBR) can be used individually or as a mixture of two or more of these compounds. As the binding agent, an aqueous binder, for example, can be used. As the aqueous binder, an aqueous dispersion, for example, of celluloses, styrene butadiene rubber (SBR), and so on can be used.

As the thickening agent, for example, polysaccharides such as carboxymethyl cellulose, methyl cellulose, and so on can be used individually or as a mixture of two or more of these compounds.

The positive electrode active material layer can be formed by a method for applying coating liquid containing, for example, the positive electrode active material to the surface of the power collecting member on the positive electrode side. Examples of the application method include roller coating with an applicator roller and the like, screen coating, doctor blade method, spin coating, and bar coating. With any one of the aforementioned application methods, the thickness and the shape of the positive electrode active material layer can be controlled to given thickness and shape.

A solvent contained in the coating liquid disperses, for example, the positive electrode active material, the conductive additive, and the binding agent. As the solvent, an organic solvent such as ethanol, N-methylpyrrolidone, dimethylformamide, dimethylacetamide, methyl ethyl ketone, cyclohexanone, methyl acetate, methyl acrylate, diethyltriamine, N,N-dimethylaminopropylamine, ethylene oxide, tetrahydrofuran can be used, for example. A substance obtained by adding a dispersant, the thickening agent, and so on to water and slurring the positive electrode active material with a latex such as SBR may be used as the coating liquid.

Examples of the material of the power collecting member include aluminum, titanium, stainless steel, nickel, iron, baking carbon, a conductive polymer, and a conductive glass. As the power collecting member, aluminum, copper, or the like having a surface processed by carbon, nickel, titanium, silver, and the like can be used. The aforementioned processing improves the adhesiveness, the conductivity, and the oxidation resistance of the power collecting member. The surface of the aforementioned power collecting member may undergo an oxidation processing. Examples of the shape of the power collecting member include a foil-like shape, a film-like shape, a sheet-like shape, a net-like shape, a punched shaped, an expanded shape, a lath shaped body, a porous body, a foam-like body, and a body formed by a group of fibers. The thickness of the power collecting member can be, for example, 1 to 500 μm.

3. Rechargeable Battery

The rechargeable battery comprises the positive electrode described in the section “2. Positive Electrode” as the positive electrode. Examples of the rechargeable battery include a lithium sulfur rechargeable battery, a sodium sulfur rechargeable battery, a magnesium sulfur rechargeable battery. In the case of the lithium sulfur rechargeable battery, the negative electrode contains lithium. In the case of the sodium sulfur rechargeable battery, the negative electrode contains sodium. In the case of the magnesium sulfur rechargeable battery, the negative electrode contains magnesium.

As the electrolytic solution that composes the rechargeable battery, a nonaqueous solvent, for example, may be used. The nonaqueous solvent is not limited, but may preferably be, for example, carbonates such as ethylene carbonate (EC), diethyl carbonate (DEC), and propylene carbonate (PC), ethers such as dimethoxyethane (DME), triglyme, and tetraglyme, cyclic ether such as dioxolane (DOL), and tetrahydrofuran, and a mixture of these substances. Moreover, as the electrolytic solution, an ionic liquid such as 1-methyl-3-propylimidazolium bis (trifluorosulfonyl) imide, and 1-ethyl-3-butylimidazolium tetrafluoroborate can be also used.

Examples of the electrolyte include lithium salts used for lithium rechargeable batteries. As the lithium salts, publically-known electrolytes such as lithium bis(trifluoro methanesulfonyl)imide (LiTFSI), Li(C₂F₅SO₂)₂N, LiPF₆, LiClO₄, and LiBF₄ can be used.

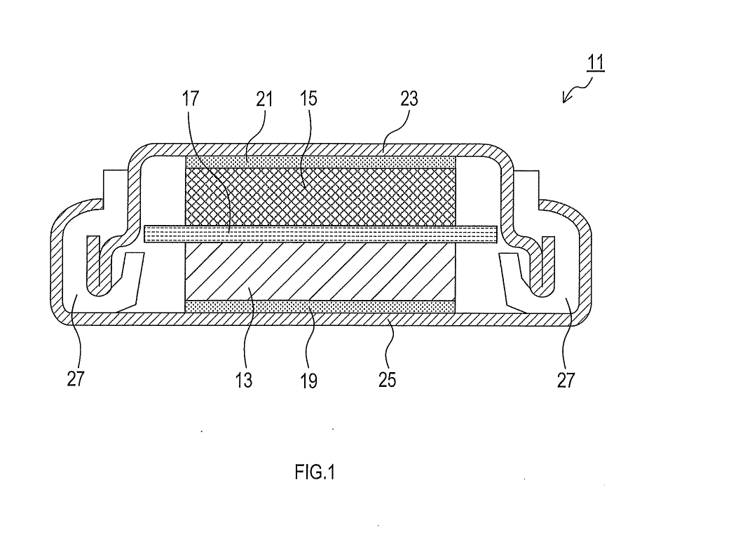

The rechargeable battery can comprise a publically-known configuration except the part of, for example, the positive electrode active material. The rechargeable battery has the configuration shown in FIG. 1, for example. A rechargeable battery 11 comprises a negative electrode 13, a positive electrode 15, a separator 17, a power collecting member 19 on the negative electrode side, a power collecting member 21 on the positive electrode side, an upper case 23, a lower case 25, and a gasket 27. A container composed of the upper case 23 and the lower case 25 is filled with a nonaqueous electrolyte.

### Embodiment

(1) Producing Silica Gel-Carbon Composite A1

22 g of a sulfuric acid having a concentration of 6 mol/L was mixed with 78 g of sodium silicate having a silica concentration of 25% to obtain 100 g of a silica sol. To this 100 g of silica sol, 62 g of a carbon black dispersed solution (W-311N: manufactured by Lion Specialty Chemicals Co., Ltd.) was added and stirred further well to obtain a generally gel-like solid matter (hydrogel). The carbon black dispersed solution corresponds to the commercially available aqueous dispersions of fine particulate carbon.

Subsequently, the aforementioned hydrogel was crashed to obtain fragments in the size of approximately 1 cm³, and batch cleaning with 1 L of ion exchange water was performed 5 times. To the hydrogel that has gone through the cleaning, 1 L of the ion exchange water was added, and the pH value was adjusted to 8 by using ammonia water. Then, a heating processing was performed at 85° C. for 8 hours. After solid-liquid separation, the solid matter was dried at 180° C. for 10 hours. As a result, 24.2 g of the silica gel-carbon composite was obtained. Subsequently, the silica gel-carbon composite was milled to obtain powder having an average particle size of 3 μm. This powder will be hereinafter referred to as a silica gel-carbon composite A1. The values of the physical properties of the silica gel-carbon composite A1 were as follows.

Specific surface area: 275 m²/g

Pore volume: 0.6 ml/g

Average pore diameter: 12 nm

Carbon content: 30.7% by mass

Electrical conductivity: 0.15 S/cm

The specific surface area, the pore volume, and the average pore diameter were calculated from nitrogen adsorption measurements. The carbon content was measured with an elemental analyzer (Vario EL III (manufactured by Elementar Analysensysteme GmbH)). The values of the physical properties of the silica gel-carbon composite A1 are shown in Table 1.

TABLE 1

| | | | | | Com- |
|---|---|---|---|---|---|
| | | | A1/ | A2/ | parative |
| | | | C1/D1 | C2/D2 | Example |
| Physical | Specific | (m²/g) | 275 | 50 | 350 |
| property | surface area | | | | |
| value | Pore volume | (ml/g) | 0.6 | 0.7 | 1.2 |
| of silica | Average pore | (nm) | 12 | 53 | 14 |
| gel-carbon | diameter | | | | |
| composite | Carbon | (% by | 30.7 | 30.9 | 0 |
| or silica | content | mass) | | | |
| gel | Electrical | (S/cm) | 0.15 | 0.51 | Insulator |
| | conductivity | | | | |
| Composition | Sulfur | (% by | 40 | 40 | 40 |
| of positive | | mass) | | | |
| electrode | Silica | (% by | 40 | 40 | 28 |
| | gel-carbon | mass) | | | |
| | composite or | | | | |
| | silica gel | | | | |
| | Conductive | (% by | 0 | 0 | 12 |
| | additive | mass) | | | |
| | Binder | (% by | 20 | 20 | 20 |
| | | mass) | | | |
| Discharge | Per sulfur | (mAh/g) | 665 | 686 | 56 |
| capacity in | Per positive | (mAh/g) | 266 | 274 | 22.6 |
| 10th cycle | electrode | | | | |
| Discharge | Per sulfur | (mAh/g) | 614 | 505 | 39 |
| capacity in | Per positive | (mAh/g) | 246 | 202 | 15.8 |
| 50th cycle | electrode | | | | |
| Discharge | Per sulfur | (mAh/g) | 540 | 442 | 33.5 |
| capacity in | Per positive | (mAh/g) | 216 | 177 | 13.1 |
| 100th cycle | electrode | | | | |

(2) Producing Silica Gel-Carbon Composite A2

22 g of the sulfuric acid having a concentration of 6 mol/L was mixed with 78 g of sodium silicate having a silica concentration of 25% to obtain 100 g of a silica sol. To this 100 g of silica sol, 62 g of the carbon black dispersed solution (W-311N: manufactured by Lion Specialty Chemicals Co., Ltd.) was added and stirred further well to obtain a generally gel-like solid matter (hydrogel). The carbon black dispersed solution corresponds to the commercially available aqueous dispersions of fine particulate carbon.

Subsequently, the aforementioned hydrogel was crashed to obtain fragments in the size of approximately 1 cm³, and batch cleaning using 1 L of the ion exchange water was performed 5 times. To the hydrogel that has gone through the cleaning, 1 L of the ion exchange water was added, and the pH value was adjusted to 8 by using the ammonia water. Then, a heating processing was performed at 85° C. for 8 hours. After solid-liquid separation, the solid matter was dried at 180° C. for 10 hours.

Subsequently, 3.8 g of 28% ammonia water was added to the solid matter after the drying, hydrothermal polymerization was performed at 180° C. for 72 hours, and then drying was performed at 180° C. for 2 hours. Consequently, 24.2 g of the silica gel-carbon composite was obtained. Then, the silica gel-carbon composite was milled to obtain powder having an average particle size of 3 μm. This powder will be hereinafter referred to as a silica gel-carbon composite A2. The values of the physical properties of the silica gel-carbon composite A2 were as follows.

Specific surface area: 50 m²/g

Pore volume: 0.7 ml/g

Average pore diameter: 53 nm

Carbon content: 30.9% by mass

Electrical conductivity: 0.51 S/cm

The method for measuring the physical properties is the same as that for the silica gel-carbon composite A1. The values of the physical properties of the silica gel-carbon composite A2 are shown in the aforementioned Table 1.

(3) Producing Positive Electrode Active Materials B1 and B2

The silica gel-carbon composite A1 and sulfur were mixed at the mass ratio of 1:1 to prepare a first mixture. The sulfur used herein was sublimated and purified sulfur manufactured by Wako Pure Chemical Corporation. 400 to 600 mg of the first mixture was milled and mixed for 2 hours by using a ball mill (P-7 manufactured by Fritsch Japan Co., Ltd.) under a condition where the speed is 300 rpm. The beads used herein were beads composed of ZrO₂ and having diameters of 1 mm.

The substance obtained as a result of the milling and mixing was heated in a vacuum-sealed glass tube at 155° C. for 12 hours. At this point, sulfur liberation was not observed. All the sulfur was physically adsorbed to the silica gel and filled in the pores of the silica gel. The substance obtained through the above-described process will be referred to as a positive electrode active material B1.

The positive electrode active material B2 was produced by basically the same production method as that for the positive electrode active material B1. However, in the case of the positive electrode active material B2, the silica gel-carbon composite A1 was replaced with the same amount of the silica gel-carbon composite A2.

(4) Producing Positive Electrode Active Material BR

The nonconductive silica, the conductive carbon, and sulfur were mixed at the mass ratio of 7:3:10 to prepare a second mixture. The nonconductive silica is Silysia 430 (manufactured by Fuji Silysia Chemical Ltd.). The values of the physical properties of Silysia 430 are as follows. The method for measuring the physical properties is the same as those for the silica gel-carbon composites A1, A2. The values of the physical properties of Silysia 430 are shown in the column of “Comparative example” in the aforementioned Table 1.

Specific surface area: 350 m²/g

Pore volume: 1.2 ml/g

Average pore diameter: 14 nm

Average particle size: 4 μm

The conductive carbon used herein is amorphous conductive carbon manufactured by Toyo Tech Co., Ltd. The sulfur used herein is the same as that used in producing the silica gel-carbon composites A1, A2.

400 to 600 mg of the second mixture was milled and mixed for 2 hours by using the ball mill (P-7 manufactured by Fritsch Japan Co., Ltd.) under a condition where the speed is 300 rpm. The beads used herein were beads composed of ZrO₂ and having diameters of 1 mm.

The substance obtained as a result of the milling and mixing was heated in a vacuum-sealed glass tube at 155° C. for 12 hours. At this point, sulfur liberation was not observed. All the sulfur was physically adsorbed to the nonconductive silica and filled in the pores of the nonconductive silica. The substance obtained through the above-described process will be referred to as a positive electrode active material BR.

(5) Producing Positive Electrodes C1, C2, and CR

The positive electrode active material B1 and the PVDF were mixed at the mass ratio of 8:2 to prepare a third mixture. Then, 20 mg of the third mixture and 0.5 mL of the NMP (N-methylpyrrolidone) were dispersed in a small vial by ultrasonic waves for 2 hours to obtain an ink-like turbid liquid. The PVDF and the NMP used herein are both products of Sigma-Aldrich Co., LLC.

This turbid liquid was applied on one side of a carbon fiber sheet (manufactured by Toyo Tech Co., Ltd.) cut into a disc shape with a diameter of 15 mm. Subsequently, the disc was dried in the air, and further dried throughout the night under vacuum to obtain a positive electrode C1. The total amount of the positive electrode active material B1 existing on the carbon fiber sheet was 1.5 to 2.5 mg.

The positive electrode C2 was produced by basically the same production method as that for the positive electrode C1. However, in the case of the positive electrode C2, the positive electrode active material B1 was replaced with the same amount of the positive electrode active material B2.

Moreover, the positive electrode CR was produced by basically the same production method as that for the positive electrode C1. However, in the case of the positive electrode CR, the positive electrode active material B1 was replaced with the same amount of the positive electrode active material BR.

The compositions of the positive electrodes C1, C2 (except the carbon fiber sheet) are shown in the aforementioned Table 1. Moreover, the composition of the positive electrode CR (except the carbon fiber sheet) is shown in the column “Comparative example” in the aforementioned Table 1. The conductive additive in Table 1 is the conductive carbon. The binder in Table 1 is the PVDF.

(6) Producing Coin Cell Batteries D1, D2, and DR

The positive electrode C1, the separator, the negative electrode, and the electrolyte were arranged in a CR2032 coin battery holder under inert atmosphere to produce the coin cell battery D1. The coin cell battery D1 is the lithium sulfur rechargeable battery. The separator, the negative electrode, and the electrolyte used herein are the ones to be described below.

Separator: solution-permeable polypropylene disc-shaped film with a diameter of 17 mm.

Negative electrode: a lithium disc with a diameter of 15 mm.

Electrolyte: a mixed solvent of Li.TFSI with a concentration of 1 mol/L and LiNO₃DOL/DME with a concentration of 0.2 mol/L mixed at the volume ratio of 1:1. Li.TFSI stands for lithiumbis (trifluoro methanesulfonyl) imide (Lithiumbis (trifluoromethanesulfonyl) imide). DOL stands for 1,3-dioxolane (1,3-dioxolane). DME stands for 1,2-dimethoxyethane (1,2-dimethoxyethane).

The coin cell battery D2 was produced by basically the same production method as that for the coin cell battery D1. However, in the case of the coin cell battery D2, the positive electrode C1 was replaced with the positive electrode C2.

Moreover, the coin cell battery DR was produced by basically the same production method as that for the coin cell battery D1. However, in the case of the coin cell battery DR, the positive electrode C1 was replaced with the positive electrode CR.

(7) Evaluation of Coin Cell Battery

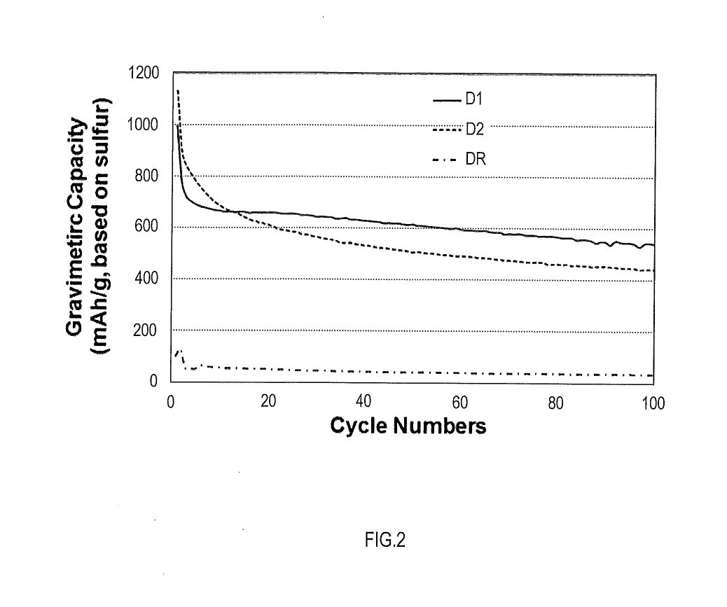

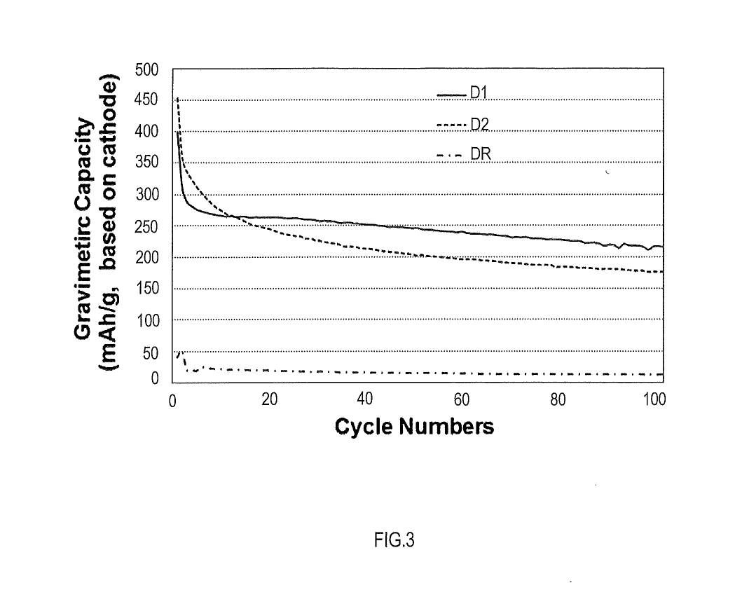

With a battery charge/discharge device manufactured by Hokuto Denko Corporation, a charging and discharging test was ran for each of the coin cell batteries D1, D2, DR. The charging and discharging speed in the charging and discharging tests was set to 1C. The test results are shown in FIG. 2 and FIG. 3. The vertical axis in FIG. 2 represents the capacity of the battery based on the mass of the sulfur in the active material. The vertical axis in FIG. 3 represents the capacity of the battery based on the mass of the active material in the positive electrode.

The results of charging and discharging tests on the coin cell batteries D1, D2 are shown in the aforementioned Table 1. The result of charging and discharging test on the coin cell battery DR is shown in the column “comparative example” in the aforementioned Table 1. “Per sulfur” in Table 1 means the capacity of the coin cell battery based on the mass of the sulfur in the active material. “Per positive electrode” in Table 1 means the capacity of the coin cell battery based on the mass of the active material in the positive electrode.

As shown in FIG. 2, FIG. 3, and Table 1, the coin cell batteries D1, D2 were larger in capacity than the coin cell battery DR. Moreover, the capacities of the coin cell batteries D1, D2 did not easily decrease regardless of the repeated charging and discharging cycles. The reason can be assumed as follows. In the coin cell batteries D1, D2, the sulfur contained in the positive electrode active materials B1, B2 is filled in the pores of the silica gel-carbon composites A1, A2. The sulfur, thus, does not easily dissolve in the electrolytic solution. Consequently, it is considered that the capacities do not easily decrease regardless of repeated charging and discharging cycles.

The above has described the embodiments of the present disclosure. The present disclosure, however, is not limited to the above-described embodiments and can be carried out in variously modified forms.

(1) A function of a single component in each of the aforementioned embodiments may be distributed to a plurality of components; functions of a plurality of components may be achieved by a single component. A part of the configuration of each of the aforementioned embodiments may be omitted; at least one part of the configuration of each of the aforementioned embodiments may be added to or altered with the configuration of another embodiment or other embodiments of the aforementioned embodiments. All the modes included in the technical idea specified by the wording described in claims are embodiments of the present disclosure.

(2) The present disclosure can be carried out in various forms such as a method for producing the positive electrode active material, a method for producing the positive electrode, and a method for producing the rechargeable battery, in addition to the above-described positive electrode active material, the positive electrode, and the rechargeable battery.

Although the present disclosure has been described with reference to one or more examples, workers skilled in the art will recognize that changes may be made in form and detail without departing from the scope of the disclosure and/or the appended claims.

1. A positive electrode active material comprising:
conductive silica; and
sulfur.

2. A positive electrode active material comprising:
conductive silica; and
sulfur filled in pores of the conductive silica.

3. The positive electrode active material according to claim 2, wherein the conductive silica is a composite comprising:
silica gel; and
fine particulate carbon dispersed in the silica gel.

4. A positive electrode comprising the positive electrode active material according to claim 3.

5. A rechargeable battery comprising the positive electrode according to claim 4.

6. The rechargeable battery according to claim 5,
wherein the negative electrode comprises at least one selected from lithium, sodium, and magnesium.

7. A positive electrode active material comprising:
a silica gel-carbon composite having:
a specific surface area of 20 to 1000 m²/g,
a pore volume of 0.3 to 2.0 ml/g, and
a carbon content of 1 to 50% by mass of the silica gel-carbon composite before addition of other materials; and
sulfur at least partially located inside pores of the silica gel-carbon composite.

8. The positive electrode active material of claim 7, wherein:
the specific surface area of the silica gel-carbon composite is between 50 and 275 m²/g inclusive;
an average pore diameter of the silica gel-carbon composite is between 12 and 53 nm inclusive;
the carbon content of the silica gel-carbon composite is between 30 and 35% by mass inclusive; and
a mass of the sulfur is approximately equal to a mass of the silica gel-carbon composite.

9. The positive electrode active material of claim 8, wherein:
the specific surface area of the silica gel-carbon composite is approximately 275 m²/g;
the average pore diameter of the silica gel-carbon composite is approximately 12 nm; and
the carbon content of the silica gel-carbon composite is approximately 30% by mass.

10. A positive electrode including:
the positive electrode active material of claim 7;
a binder; and
no conductive additive.

11. The positive electrode of claim 10, wherein:
the sulfur is approximately 40% by mass of the positive electrode;
the silica gel-carbon composite is approximately 40% by mass of the positive electrode; and
the binder is approximately 20% by mass of the positive electrode.

12. A positive electrode including:
the positive electrode active material of claim 8;
a binder; and
no conductive additive.

13. The positive electrode of claim 12, wherein:
the sulfur is approximately 40% by mass of the positive electrode;
the silica gel-carbon composite is approximately 40% by mass of the positive electrode; and
the binder is approximately 20% by mass of the positive electrode.

14. A positive electrode including:
the positive electrode active material of claim 9;
a binder; and
no conductive additive.

15. The positive electrode of claim 14, wherein:
the sulfur is approximately 40% by mass of the positive electrode;
the silica gel-carbon composite is approximately 40% by mass of the positive electrode; and
the binder is approximately 20% by mass of the positive electrode.
